(19) United States
(12) Patent Application Publication
(10) Pub. No.: US 2007/0245803 A1
(43) Pub. Date: Oct. 25, 2007

(54) OXYGEN SENSOR WITH A PROTECTIVE LAYER

(76) Inventors: Siong Sing Tan, Chino, CA (US); Chen-Shing Chang, Pingjhen City (TW)

Correspondence Address: KNOBBE MARTENS OLSON & BEAR LLP, 2040 MAIN STREET, FOURTEENTH FLOOR, IRVINE, CA, 92614, US

(21) Appl. No.: 11/677,897

(22) Filed: Feb. 22, 2007

Related U.S. Application Data
(60) Provisional application No. 60/776,132, filed on Feb. 23, 2006.

(51) Int. Cl. G01N 7/00

(52) U.S. Cl. 73/31.05

(57) ABSTRACT

An exhaust gas sensor comprises a planar sensing element, which comprises a ceramic heater, a solid electrolyte electrochemical cell, and a protection layer for the sensing electrode and electrode leads. The protection layer comprises built-in arrays of porous vias.

### CROSS-REFERENCE TO RELATED APPLICATIONS

This application hereby claims the priority of U.S. Provisional Patent Application No. 60/776,132, which was filed on Feb. 23, 2006 and which is hereby incorporated by reference in its entirety.

### BACKGROUND OF THE INVENTION

1. Field of the Invention

The present invention generally relates to planar oxygen sensors. More particularly, the present invention relates to improved constructions of such oxygen sensors.

2. Description of the Related Art

For vehicles equipped with an internal combustion engine, an oxygen sensor positioned along the exhaust system can be used to detect rich and lean air-fuel mixtures based upon the amount of oxygen in the engine exhaust. The mechanism in most oxygen sensors used to detect the oxygen level involves a chemical reaction that generates a voltage (i.e., an electromotive force or EMF). The engine's computer control module (ECM) looks at the voltage to determine if the mixture is rich in fuel (i.e., reduced levels of oxygen, high EMF) or lean in fuel (i.e., excess levels of oxygen, low EMF) in fuel. When the mixture is rich, the voltage level is higher. When the mixture is lean, the voltage level is lower. The ECM can adjust the amount of fuel entering the engine based upon the detected voltage level. The goal typically is to achieve a stoichiometric ratio at which the engine produces the lowest levels of hydrocarbons (HC), carbon monoxide (CO) and oxides of nitrogen (NOx).

Therefore, the function of the oxygen sensor is to help the engine run efficiently with reduced emissions. Traditional engine control algorithms would like to see the sensors cross over the stoichiometric mid-point (e.g., a voltage around 450 mV) at steady state as well as during dynamic engine operation for extended operating life under harsh engine operating environments.

### SUMMARY OF THE INVENTION

For both conical (i.e., thimble) and planar (e.g., flat plate) oxygen sensors, a porous ceramic protective layer covers the electrode on the exhaust gas side to protect the electrode from direct exposure to the exhaust gas being measured. In most planar oxygen sensors, a protective layer made of porous ceramic material (e.g. spinel, alumina, or the like) may be deposited over the otherwise exposed electrodes to protect the sensing electrode from abrasion and from poisoning by the exhaust gases. This porous layer can be combined with a poison-resistant coating to achieve better durability and a truer reading of exhaust gases. This protection layer typically is made by a multilayer ceramic fabrication method that involves lamination of green sheets followed by co-sintering to form a layer of porous ceramic 50 on the top of a dense ceramic body 52 as shown in FIG. 1.

Due to the mismatch in green sheet densities upon lamination, there is a difference in sintering shrinkage behavior among the porous ceramic layer 50, the dense insulating ceramic layer 52, and the zirconia layer 54. Due to the difference in sintering shrinkage behavior, gaps tend to form along joints between the porous ceramic layer 50 and the dense ceramic layer 52 while cracks are usually seen on the zirconia layer 54 right beneath the joint line. These structural defects on the surface of each ceramic layer frequently develop into major cracks penetrating to other layers during sensor element testing, and/or during oxygen sensor assembly and testing. In many cases, the tiny cracks result in a detrimental fracture of the sensor element under vehicle operation conditions.

Also, due to mismatches in sintering shrinkages between the porous layer 50 (which has a relatively lower firing shrinkage rate) and the dense ceramic layers 52 (the insulator and electrolyte shrink more during sintering), the straightness and flatness in this portion of the sensor element is very difficult to maintain. Straightness and flatness are required for a planar sensor element to be packaged properly into oxygen sensor metal harness, as well as for preventing local stress concentration points due to curvatures.

### BRIEF DESCRIPTION OF THE DRAWINGS

These and other features, aspects and advantages of the present invention will now be described with reference to the drawings of a preferred embodiment, which embodiment is intended to illustrate and not to limit the invention, and in which figures:

FIG. 1 is prior art planar oxygen sensor construction;

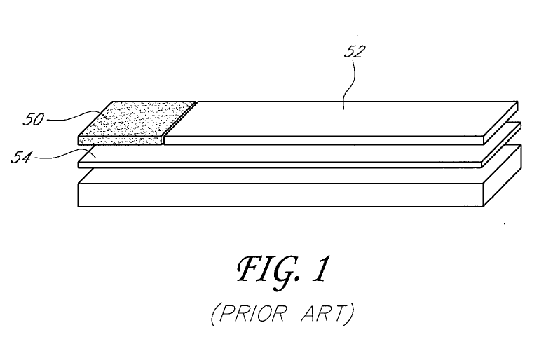

FIG. 2 is an exploded view of an oxygen sensor construction that is arranged and configured in accordance with certain features, aspects and advantages of the present invention;

FIGS. 3(a) through 3(f) are different configurations of vias that can be used in the construction of the sensor of FIG. 2.

FIG. 4 is an exploded view of another oxygen sensor construction that is arranged and configured in accordance with certain features, aspects and advantages of the present invention;

FIGS. 5(a) and 5(b) are schematic representations of multiple heater configurations; and

FIGS. 6(a) through 6(c) are additional schematic representations of further heater configurations.

### DETAILED DESCRIPTION OF THE PREFERRED EMBODIMENT

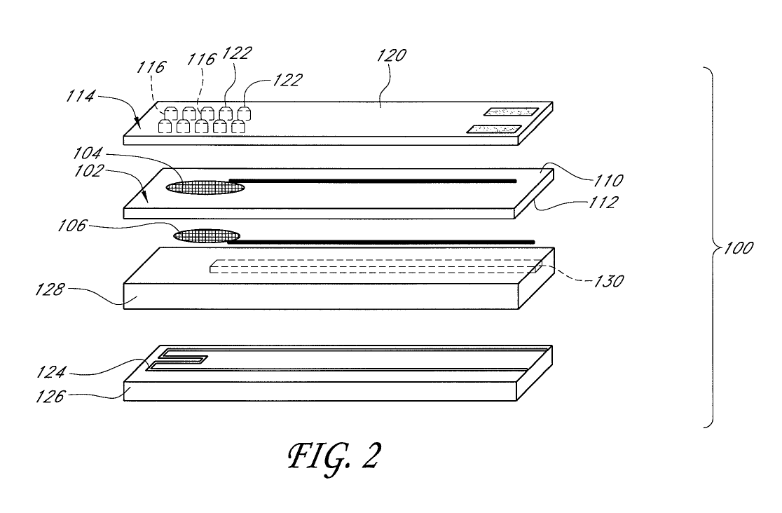

With reference now to FIG. 2, a planar oxygen sensor 100 is provided. The sensor 100 can be used for fuel/air ratio control in some applications. The sensor 100 also can be used in other applications, such as, for example but without limitation, NOx sensors, hydrocarbon sensors, ammonia sensors, hydrogen sensors, chemical sensors, and sensing devices contain a plate heater.

The sensor 100 preferably is an electrolytic oxygen sensor that comprises, at least in part, an oxygen ion-conductive body 102. In one configuration, the body 102 is formed of zirconia. Other suitable materials also can be used.

The body 102 preferably is interposed between a first electrode 104 and a second electrode 106. More preferably, the first electrode 104 and the second electrode 106 are in intimate contact with the body 102. The electrodes 104, 106 preferably are formed of platinum. Other materials also can be used. A first side 110 of the body 102 will be positioned on the exhaust gas side while an opposite second side 112 will be positioned on the ambient or reference air side.

In the illustrated configuration, the first side 110 of the body 102 (i.e., the side that will be proximate the exhaust gases) preferably is protected by a diffusion layer 114. The diffusion layer 114 can comprise a ceramic body 120 that, in some embodiments, can be made primarily of ceramics of alumina, pure zirconia, partially stabilized zirconia, yttria, magnesia, titania and rare earth oxides. Other configurations can be made primarily of alumina-magnesium spinel ceramics, glass ceramics and ceramic composites. Yet other configurations also are possible.

The diffusion layer 114 can comprise arrays of vias 116 that are defined in the otherwise dense ceramic body 120. As used herein, vias 116 are pathways. In some configurations, the vias 116 can be formed in the ceramic body 120 devoid of a noble metal catalyst or an oxygen storage component. Other configurations may be possible.

The diffusion layer 114 preferably comprises controlled porosity, pore size, pore size distribution, and gas diffusion characteristics. Thus, the diffusion layer 114 desirably substantially protects the first electrode 104 (i.e., the exhaust gas side electrode) from high-velocity harsh exhaust gases. In other words, by providing the protective porous surface (e.g., the diffusion layer 114), the likelihood of harmful gases contaminating the sensing electrode 104 is greatly reduced or eliminated.

In another configuration, precious metal oxides and alloys of platinum, rhodium, palladium, iridium, cadmium, ruthenium, gold, silver, tantalum, molybdenum, niobium, tungsten, and catalytic materials, including oxide ceramics and metal alloys (e.g., with a loading ratio of about 0-5% by total weight) can be added into the ceramic main body 120. In some configurations, these materials can be added by dry or wet mixing with ceramic powders before ceramic firing. In some configurations, these materials can be added by a slurry-based impregnation followed by a post firing process. Other processes also can be used. The precious metals and catalytic materials can provide functions of catalysts and/or oxygen storage components within the vias 116 of the ceramic body 120.

With reference still to FIG. 2, a set of vias can be filled with a more porous ceramic material such that more porous ceramic bodies 122 are embedded in the dense ceramic body 120. The vias 116, 122 preferably are disposed directly adjacent, or directly above, the first electrode 104. Advantageously, by providing the more porous ceramic bodies 112 in the illustrated configuration, a monolithic dense ceramic body 120 can be used instead of a layer that is configured with a portion that is dense and a portion that is more porous. The vias and the ceramic bodies therein 116, 122 allow exhaust gas to permeate through the ceramic body 120 to reach the sensor electrode surface in a generally even manner.

The porous ceramic bodies 122 in the vias 116 can be formed in any suitable manner. In one configuration, the vias 116 are formed by traditional ceramic processes. In another configuration, the vias 116 are formed by thin-film semiconductor techniques. For example, the porous ceramic bodies 122 can be formed with filling substances, including but not limited to, organic-based transient materials, which can be removed by sintering, post firing, wet chemical etching or dry plasma-based etching processes. In other words, the vias can be formed by, and can be filled using, traditional ceramic fabrication methods including but not limited hole punching or drilling, screen printing, pressurized via filling, and replaced by a performed green tape of the same size; or by other thick-film hybrid and thin-film techniques including but not limited to surface mount, dry or wet layer buildup by screen/stencil printing, and photo lithography methods. In other configurations, such as for more sophisticated exhaust gas sensors, catalyst and/or oxygen storage materials can be dispersed in the porous material 122 contained in the vias 116.

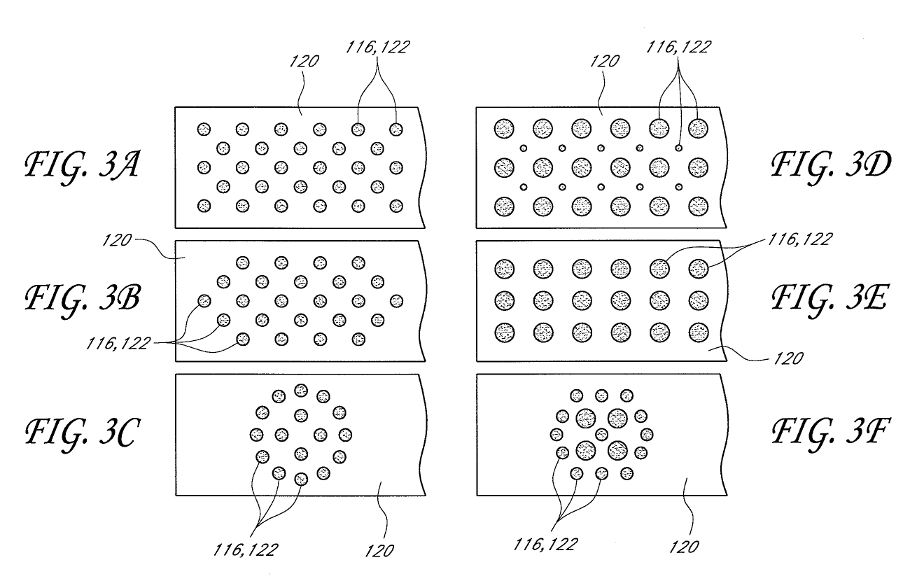

With reference to FIGS. 3(a)-3(f), various configurations of the vias 116 and the related porous ceramic bodies 122 are illustrated. Preferably, the vias 116 and bodies therein 122 are configured to reflect the size and shape of the sensor electrode that is positioned below the vias and bodies 122. As illustrated, the vias 116 and porous ceramic bodies 122 can be of generally uniform size and configuration. The vias 116 and porous ceramic bodies 122 can have varied sizes. In some configurations, the vias 116 and porous ceramic bodies 122 can have a diameter of between about 0.1 mm and about 1.5 mm. In some configurations, the porous ceramic bodies 122 have the same general porosity while, in other configurations, the porosity may vary. The vias 116 and porous ceramic bodies 122 can be arranged in any desired configuration. In the more preferred configurations, the vias 116 and the porous ceramic bodies can be generally orderly and symmetrical in appearance. Such configurations provide an advantage in predictability. Other configurations, however, can be used. Vias and porous ceramic body designs including the numbers, location, patterns, diameters, lengths, porosities, pore sizes, pore size distribution, gas permeability, and chemical ingredient provide desired functionalities as a protection layer and a diffusion barrier that can control a limiting current when an exhaust oxygen sensor is operated as air-fuel linear oxygen sensor; and as exhaust species sensor to detect, for example but without limitation, NOx, ammonia, CO₂, CO, hydrocarbons, and/or hydrogen gas.

A resistance heater 124 can be positioned beneath the body 102. The illustrated heater 124 is mounted to a ceramic body 126. Other configurations also are possible. In one configuration, an air reference channel 130 is positioned between the body 102 and the heater 124. The air reference channel 130 preferably is in fluid communication with ambient air and can be disposed within a ceramic body 128. Thus, the heater 124 can be interposed between two ceramic bodies 126, 128. Other configurations are possible.

The diffusion layer 114, the body 102, the electrodes 104 and the heater 124 can be co-fired together or each component (e.g., the protective layer, the sensing layer, the heating layer) can be separately fired and each fired component can be glued together using high temperature glues.

With respect to the sensor 100 described above, the sintered porous ceramic bodies 122 in the vias 116 preferably have porosity between about 10 percent and about 40 percent with a pore size distribution in the range of about 1 micrometer to about 20 micrometers. Preferably, the porous ceramic bodies 122 and the vias 116 extend substantially or completely through the thickness of the diffusion layer 114 and the diameter of each porous ceramic body 122 and associated via 116 ranges from about 50 micrometers to about 2 millimeters. Such a construction is believed to properly function under normal vehicular operating conditions.

The solid portion of the filling material used to form the porous ceramic bodies 122 can comprise a portion primarily formed of ceramics of alumina, pure zirconia, partially stabilized zirconia, yttria, magnesia, titania, rare earth oxides, alumina-magnesium spinel ceramics, glass ceramics, and ceramic composites. In some configurations, precious metals and alloys of platinum, rhodium, palladium, iridium, cadmium, ruthenium, gold, silver, tantalum, molybdenum, niobium, tungsten, and catalytic materials including oxide ceramics and metal alloys (with a loading ration of about 0 percent to about 10 percent by total weight) can be added by any suitable technique. For instance, in some configurations, these materials are added by dry or wet mixing with ceramic powders before ceramic firing or by a slurry-based impregmentation followed by a post firing process. Other processes also can be used.

In some applications, an overcoat on top of the protective coating can be applied by slurry dip coating, 2-D or 3-D stencil printing, flame spraying, or by plasma spraying. The overcoat preferably provides a thermal barrier to reduce the likelihood of thermal shock to the ceramic sensor. The protective coating can be identical in composition to the via filling material, or the protective coating can be different in composition while being complementary to the functionality of the via filling material in terms of gas diffusion control, catalytic reaction. Preferably, the protective coating can provide enhanced thermal properties in terms of functioning as a thermal barrier from exhaust heat. More preferably, the protective coating can provide enhance thermal properties in terms of improving thermal shock resistance due to water splash and the like.

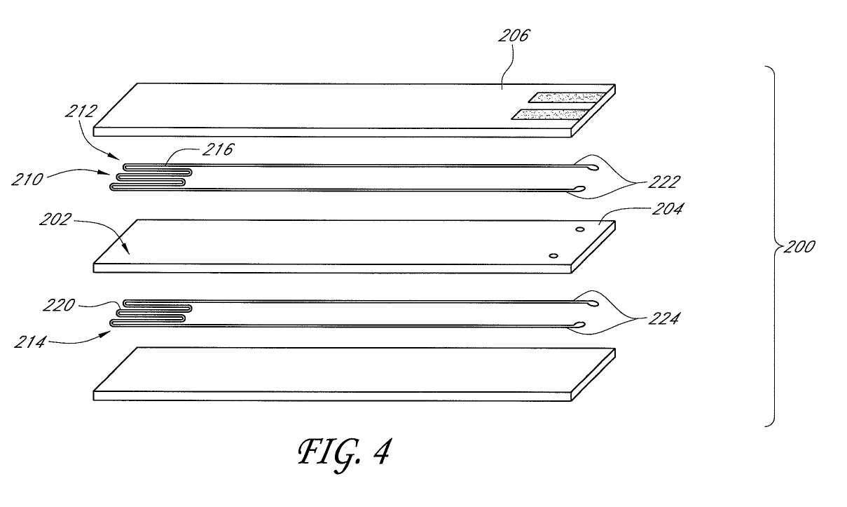

FIG. 4 illustrates another embodiment of a planar oxygen sensor 200 that is arranged and configured in accordance with certain features, aspects and advantages of the present invention. The illustrated sensor 200 can be used for open-loop applications and can be used for automotive exhaust sensors when combined with any suitable closed-loop heater voltage control mechanism.

The sensor 200 comprises a planar sensing element 202. The planar sensing element 202 can have any suitable configuration. As discussed above, the planar sensing element can comprise a solid electrolyte electrochemical cell 204, a diffusion layer 206 and a ceramic heater 210.

The electrochemical cell 204 can comprise an electrolyte layer with an electrode positioned on each side of the electrolyte layer. The diffusion layer 206 preferably comprises diffusion limited vias proximate the electrodes and the electrode leads of the cell 204, in a manner such as that described above.

The ceramic heater 210 preferably is an integrated isothermal thick-film heater comprising multiple heaters 212, 214. Advantageously, the heaters 212, 214 can heat the electrochemical detecting portion 204. The isothermal thick film heater 210 can mitigate thermal stress on the ceramic sensor 200 during sensor light off by achieving and maintaining a desired temperature profile around a periphery portion of the sensing electrode. The isothermal thick film heater 210 also can provide high rush heater wattage per unit heating surface. Therefore, a fast light off can be obtained. Accordingly, certain aspects of the illustrated sensor 200 can reduce the likelihood of localized overheating, can less the heater temperature variation during high temperature operation and can prolong heater life by reducing the wattage density on the platinum serpentines.

The ceramic heater 210 allows the creation of predetermined temperature profiles. For example, through changes in the heater pattern design for each individual heater serpentine 216, 220, through changes of thermistor materials having different coefficients of thermal resistivity (including platinum, rheodinium and palladium alloys and tungsten, tantalum and molybdenum based heater) and through changes in the thickness and/or or width of the heater serpentine 216, 220, the temperature profile from the center to the perimeter of the substrate can be varied.

The heaters 212, 214 can be formed in any suitable manner. In some embodiments, the heaters 212, 214 are made by screen printing, ink jet printing, pattern transferring, patterned foil perform transferring and/or by photolithic methods. The heaters 212, 214 can be formed on a fired ceramic substrate or can be co-fired into a monolithic body.

Preferably, the heater leads 222, 224 have lower values of room temperature electrical resistance. The heater leads 222, 224 can be made of the same or different heater lead material. In one configuration, the temperature coefficient of electrical resistance (TCR) values of the heater leads 222, 224 are much smaller than those values of the heater serpentines 216, 220. The TCR values for the serpentine 216 and the second serpentine 220 are preferred to be much different.

Examples of heater sheet resistance values and TCR values for exemplary heater leads and heater serpentines can include:

| | H1-Leads | H1-Serp | H2-Leads | H2-Serp |
|---|---|---|---|---|
| TCR %/° C. | 0.05-0.15 | 0.10-0.20 | 0.05-0.15 | 0.50-2.00 |
| Sheet Resistance | 20-30 | 50-100 | 20-30 | 25-50 |
| m-ohm/square | | | | |

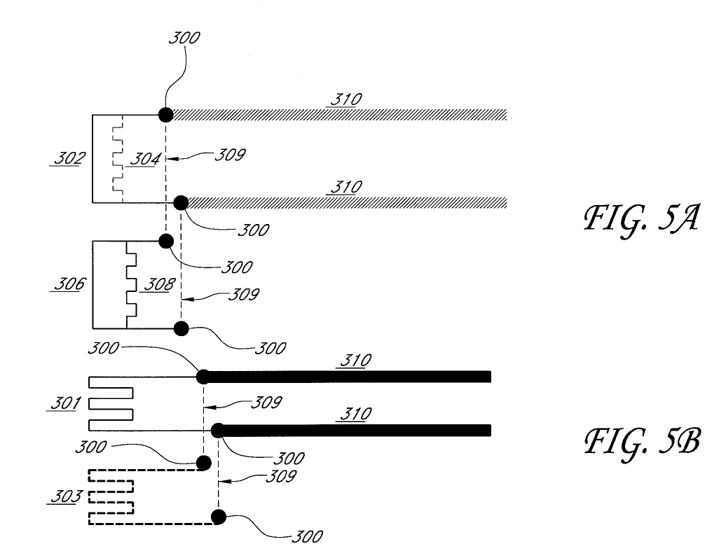

With reference now to FIG. 5a and FIG. 5b, several different examples of multiple heaters on different planes are shown. The multiple heaters preferably are electrically linked through vias 300. The heaters can have any suitable configuration and, in the illustrated configurations, are placed in two or more different planes of the associated sensor. In some configurations, three or more heaters can be used.

The heaters comprise heater leads 310. The heater leads 310 can be connected to one or more heaters through vias 309. Other configurations also can be used. Desirably, the heater leads 310 and the electrical vias 309 have relatively lower electrical resistance values and lower temperature coefficient of resistance (TCR) than associated heater serpentines 301, 302, 303, 304, 306 and 308. In some configurations, the electrical resistance values (affected by Pt material electrical resistivity, heater print height and heater print width) and TCR values are selected such that the outer heater serpentines 302, 306 heat up more quickly that the inner heater serpentines 304, 308. When the sensor is first powered up while at a low temperature, electrical current passes through both of the heater resistors (i.e., the serpentines) and both of the heater resistors heat up according to W=I²*R=I*V (W=heater power, I=electrical current, R=heater resistance, V=applied voltage). When the local temperature reaches a predetermined temperature, which can be a high value, one of the heater resistor sets (e.g., 302/304 or 306/308) shuts down due to a relatively high electrical resistance that generally stops electrical current flowing through the respective heater resistor.

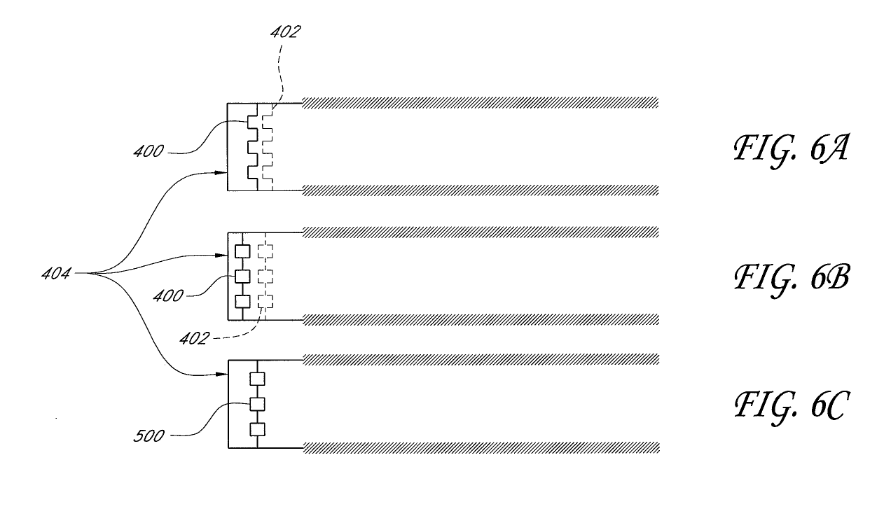

In some configurations, multiple heaters can be positioned in a single plane of the associated sensor. For instance, with reference to FIGS. 6(a) and 6(b), two different embodiments are illustrated in which multiple heater resistors 400, 402 are positioned in a co-planar manner. FIG. 6(c) illustrates another embodiment in which a single heater resistor 500 is positioned in the associated sensor. It also is possible to place multiple heaters in a single plane together with one or more additional heaters in one or more additional planes. Preferably, the heater serpentines 400, 402, 404 and 500 have differing room temperature resistance and TCR values such that a rapid heat up can be produced followed by a self-regulated heating through one or more predetermined heater resistor, but less than all of the heater resistors.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A planar sensor comprising:
an oxygen ion-conductive body comprising a first side and a second side;
a sensing electrode positioned along the first side of the body and a reference electrode positioned along the second side of the body, the sensing electrode and the reference electrode being in intimate contact with the body;
a diffusion layer extending over the first side of the body; and
a plurality of vias formed in a portion of the diffusion layer overlying at least a portion of the sensing electrode, a porous ceramic filler positioned in two or more of said plurality of vias such that said filled vias comprise a more porous member relative to the diffusion layer.

2. The sensor of claim 1, wherein the electrodes are formed of platinum.

3. The sensor of claim 1, wherein the diffusion layer comprises a ceramic body made primarily from a material selected from the group consisting of ceramics of alumina, pure zirconia, partially stabilized zirconia, yttria, magnesia, titania and rare earth oxides.

4. The sensor of claim 1, wherein the diffusion layer comprises a body made primarily of alumina-magnesium spinel ceramics, glass ceramics and ceramic composites.

5. The sensor of claim 1, wherein said plurality of vias are generally devoid of a noble metal catalyst.

6. The sensor of claim 1, wherein said plurality of vias are generally devoid of an oxygen storage component.

7. The sensor of claim 1, wherein the diffusion layer comprises a material selected from the group consisting of precious metal oxides and alloys of platinum, rhodium, palladium, iridium, cadmium, ruthenium, gold, silver, tantalum, molybdenum, niobium, tungsten, catalytic materials, and oxide ceramics and metal alloys.

8. The sensor of claim 1, wherein the vias containing the porous ceramic filler are positioned directly adjacent the sensing electrode.

9. The sensor of claim 1, wherein the vias containing the porous ceramic filler are positioned directly above the sensing electrode.

10. The sensor of claim 1, wherein the vias containing the porous ceramic filler are generally uniformly dispersed relative to the sensing electrode.

11. The sensor of claim 1, wherein the vias containing the porous ceramic filler are generally symmetrically dispersed relative to the sensing electrode.

12. The sensor of claim 1 further comprising a heater positioned beneath the oxygen ion-conductive body.

13. The sensor of claim 12, wherein the heater comprises an isothermal thick-film heater.

14. The sensor of claim 13, wherein the thick-film heater comprises multiple heaters.

15. The sensor of claim 14, wherein the multiple heaters comprise a first heater and a second heater, the first and second heater being positioned on different planes.

16. The sensor of claim 14, wherein the multiple heaters comprise a first heater and a second heater, the first and second heater comprising differing serpentine patterns.

17. The sensor of claim 14, wherein the multiple heaters comprise a first heater and a second heater, the first and second heater comprising differing thermistor materials.

18. The sensor of claim 14, wherein the multiple heaters comprise a first heater and a second heater, the first and second heater comprising differing thicknesses.

19. The sensor of claim 14, wherein the multiple heaters comprise a first heater and a second heater, the first and second heater comprising differing widths.
